(19) United States
(12) Patent Application Publication
(10) Pub. No.: US 2008/0214727 A1
(43) Pub. Date: Sep. 4, 2008

(54) Method for Producing Polyurethane Layers and Use Thereof as Imitation Leather

(75) Inventors: Wolfgang Pohl, Munchen (DE); Cord Schmalkuche, Damme (DE); Holger Leifheit, Munchen (DE); Stefan Quaiser, Danne (DE); Cheun-Gwo Chen, Taipei (TW); Wei Liang, Hsing Chu City (TW)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/908,338

(22) PCT Filed: Mar. 16, 2006
(86) PCT No.: PCT/EP2006/060791

§ 371 Date: Sep. 11, 2007

(30) Foreign Application Priority Data
Mar. 17, 2005 (DE) 102005012812.2

(51) Int. Cl. C08G 18/08; C08L 75/04

(52) U.S. Cl. 524/589; 528/75

(57) ABSTRACT

The invention concerns a process, preferably a solventless process, for producing a polyurethane layer and its use as artificial leather.

This invention relates to a process, preferably a solventless process, for producing a polyurethane layer and to its use as artificial leather.

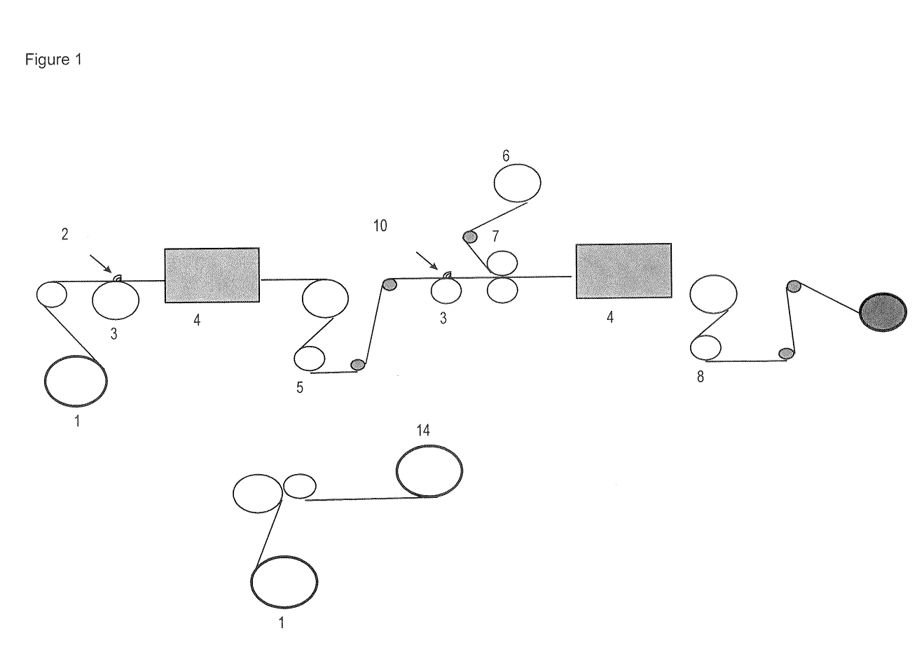

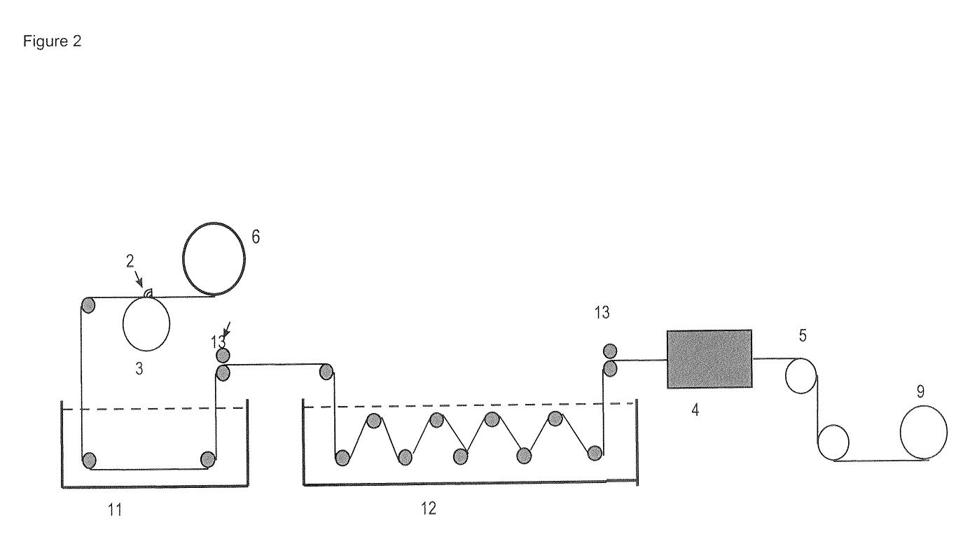

The use of polyurethane resins for producing artificial leather is known in that, for example, EP 1143063 describes suitable resins. Two processes are customary in the art for producing artificial leather, known as the dry process and as the wet process respectively. The dry process typically utilizes polyurethane resins, while polyurethane suspensions are used in the wet process. The dry process is illustrated in FIG. 1 and the wet process in FIG. 2.

The reference numerals in FIGS. 1 and 2 are each assigned the following meanings:
1 release layer
2 application of polyurethane resin in solvent
3 knife coater
4 oven
5 chill roller
6 substrate layer
7 laminating roller
8 cooling drum
9 product spindle
10 application of PU suspension
11 coagulation bath
12 wash bath
13 squeeze roller
14 artificial leather

The two processes have in common that they are costly and inconvenient, in particular since an appreciable amount of solvents has to be used in the processes to dissolve the polyurethane resins and the polyurethane suspension respectively.

The present invention accordingly has for its object to provide a process for producing a polyurethane layer preferably useful as artificial leather that is less costly and inconvenient to operate than existing processes. The present invention has for its object in particular to provide a solventless process for producing a polyurethane layer preferably useful as artificial leather. The present invention further has for its object to provide a process for producing a polyurethane layer preferably useful as artificial leather that are actualized using a short manufacturing line, for example of about 20 to 40 meters.

We have found that this object is achieved when it is not polyurethane in a solvent which is applied, but polyurethane system components which, after they have been applied, cure to form the polyurethane. More particularly, we have found that this object is achieved by applying specifically developed polyurethane system components.

The present invention accordingly provides a process for producing a polyurethane layer comprising the steps of
i) providing a release layer,
ii) applying polyurethane system components atop the release layer,
iii) if appropriate, applying a substrate layer atop the polyurethane system
components,
iv) curing the polyurethane system components to form a polyurethane layer,
v) separating the release layer from the polyurethane layer.

The process of the present invention serves to produce a polyurethane layer which is in accordance with the present invention. The thickness of this polyurethane layer is typically in the range from 0.01 mm to 20 mm, preferably in the range from 0.1 mm to 10 mm and more preferably in the range from 0.5 mm to 5 mm.

The present invention likewise provides a polyurethane layer obtainable by the process of the present invention.

The process of the present invention comprises a release layer in step i). In principle, the release layer may be any layer enabling polyurethane system components to be applied thereatop and be reacted to form polyurethane and the resulting polyurethane to be released again from the release layer.

The thickness of the release layer is typically in the range from 0.001 millimeter (mm) to 10 mm, preferably in the range from 0.01 mm to 5 mm and especially in the range from 0.1 mm to 2 mm.

Useful release layers are typically known as release papers in the art. Examples of useful release layers are layers, for example foils, composed of metal, plastic or paper.

The release layer used in one preferred embodiment is a paper layer with or without a coating of plastic. The paper layer here is preferably coated with a polyolefin, preferably polypropylene. A preferred alternative is for the paper layer to be coated with silicone.

In one alternative preferred embodiment, the release layer used is a polyethylene terephthalate (PET) layer, which is coated with a plastic if appropriate. Preferably, the PET layer is here coated with a polyolefin, preferably polypropylene. A preferred alternative is for the PET layer to be coated with silicone.

Examples of useful release layers are commercially available. Examples of renowned manufacturers in this field include Warren (Sappi, USA), Binda (Italy), Arjo Wiggins (UK/USA) and Lintec (Japan).

The release layers used may have smooth or uneven surfaces. The identity of the release layer here depends on the surface desired for the polymeric layer which results in the process of the present invention. When a smooth surface is desired for a resulting polyurethane layer, the release layer will likewise have a smooth surface. When an uneven or patterned surface is desired for a resulting polyurethane layer, the release layer will likewise have uneven or patterned surface.

The release layer is preferably patterned such that the product will have a leather grain.

Polyurethane system components are applied atop the release layer in step (ii) of the present invention's process. They are preferably only applied atop one side of the release layer.

The polyurethane system components are preferably applied uniformly; that is, the polyurethane system components are preferably applied such that the entire surface of the release layer is covered with polyurethane system components.

The polyurethane system components can generally be applied using all methods of applying a layer of polyurethane system components which are curable to form a polyurethane layer of suitable thickness. The polyurethane system components are preferably applied by casting or spraying.

Casting typically refers to the application of a liquid material (polyurethane system components) by means of a mixing head. It is preferable to use commonly employed mixing heads operated under high or low pressure; for example, Puromats from Krauss Maffei are used as a metering unit. The material is preferably applied in a laminar stream of material.

Spraying refers to application of a liquid material via a spray head. The spray head preferably atomizes the material into droplets, in particular fine droplets. A fan-shaped jet of spray is preferably formed in the process. It is preferable here for the polyurethane system components to be spray applied in the form of particles (which particles are preferably in the form of droplets) having a particle diameter in the range from 1 to 500 μm and more preferably in the range from 10 to 100 μm.

The polyurethane system components are typically applied in the process of the present invention such that the thickness of the resulting polyurethane layer is in the range from 0.01 millimeter (mm) to 20 mm, preferably in the range from 0.1 mm to 10 mm and more preferably in the range from 0.5 mm to 5 mm.

Polyurethane system components typically comprise an isocyanate component (a) and a polyol component (b).

The isocyanate component (a) comprises polyisocyanates. The polyisocyanates used comprise the customary aliphatic, cycloaliphatic and in particular aromatic di- and/or polyisocyanates. Preference is given to using tolyene diisocyanate (TDI), diphenylmethane diisocyanate (MDI) and mixtures of diphenylmethane diisocyanate and polyphenylene polymethylene polyisocyanates (polymeric MDI), especially diphenylmethane diisocyanate (monomeric MDI).

The isocyanates or else hereinbelow described isocyanate prepolymers may also be modified, for example through incorporation of uretdione, carbamate, isocyanurate, carbodiimide or allophanate groups. It is further possible to use blends of the various isocyanates. Carbodiimide-modified isocyanates are preferably used. They are preferably used in an amount from 1% to 20% by weight and more preferably in an amount from 2% to 10% by weight, based on the total weight of isocyanate component (a).

The polyisocyanates (a) can also be employed in the form of polyisocyanate prepolymers. These prepolymers are known in the art. They are prepared in a conventional manner by reacting above-described polyisocyanates (a) with hereinbelow described compounds having isocyanate-reactive hydrogen atoms (b) to form the prepolymer. The reaction may be carried out at temperatures of about 80° C. for example. The polyol/polyisocyanate ratio is generally chosen such that the NCO content of the prepolymer is in the range from 8% to 25% by weight, preferably in the range from 10% to 24% by weight and more preferably in the range from 13% to 23% by weight.

A mixture of diphenylmethane diisocyanate and polytetrahydrofuran (PTHF), in particular PTHF having a number average molecular weight in the range from 1000 to 2500, is more preferably used as isocyanate component (a). The NCO content of this mixture is preferably in the range from 14% to 22% and more preferably in the range from 16% to 20%.

The polyol component (b) may in principle comprise compounds having isocyanate-reactive hydrogen atoms. These compounds are such as bear two or more reactive groups selected from OH groups, SH groups, NH groups, NH₂ groups and acidic CH groups, such as β-diketo groups for example, in the molecule. Depending on the choice of component (b), the term “polyurethanes” shall refer in the realm of this invention to polyisocyanate polyaddition products in general, including polyureas for example.

The polyol component (b) preferably comprises polyetherols and polyesterols. These are commonly known and described for example in “Kunststoffhandbuch Polyurethane”, Günter Oertel, Carl-Hanser-Verlag, 2nd edition 1983, chapter 3.1.1. Alternative designations likewise customary in the art are polyetherpolyols or polyether alcohols on the one hand and polyesterpolyols or polyester alcohols on the other.

When polyesterols are employed, these are typically prepared by condensation of polyfunctional alcohols having from 2 to 12 carbon atoms, preferably from 2 to 6 carbon atoms, with polyfunctional carboxylic acids having from 2 to 12 carbon atoms, examples being succinic acid, glutaric acid, adipic acid, suberic acid, azaleic acid, sebacic acid, decanedicarboxylic acid, maleic acid, fumaric acid and preferably phthalic acid, isophthalic acid, terephthalic acid and the isomeric naphthalenedicarboxylic acids.

When polyetherols are used, these are generally prepared by known processes, for example by anionic polymerization using alkali metal hydroxides as catalysts and with addition of a starter molecule comprising plural reactive hydrogen atoms in attachment, from one or more alkylene oxides selected from propylene oxide (PO) and ethylene oxide (EO), butylene oxide and tetrahydrofuran.

Useful polyetherols (b) further include low-unsaturation polyetherols as they are known. Low-unsaturation polyols for the purposes of this invention are in particular polyether alcohols comprising less than 0.02 meq/g and preferably less than 0.01 meq/g of unsaturated compounds. Polyether alcohols of this type are prepared via addition of ethylene oxide and/or propylene oxide and mixtures thereof onto at least difunctional alcohols in the presence of so-called double metal cyanide catalysts.

The alkylene oxides may be used individually, alternatingly in succession or as mixtures. The use of an EO-PO mixture gives a polyetherpolyol having randomly distributed PO/EO units. It is possible to begin by using a PO-EO mixture and then, prior to termination of the polymerization, continue use of just PO or EO, the product then being a polyetherpolyol having a PO end cap or, respectively, an EO end cap.

Starter molecules used are typically NH- or OH-functional compounds such as water, amines or alcohols. Preference is given to using di- to hexahydric alcohols, such as ethanediol, 1,2-propanediol, 1,3-propanediol, diethylene glycol, dipropylene glycol, 1,4-butanediol, 1,6-hexanediol, glycerol, trimethylolpropane, pentaerythritol and/or sorbitol.

It is preferable to use polyetherols obtained by ring-opening polymerization of tetrahydrofuran. These polytetrahydrofurans preferably have a functionality of about 2. They preferably further have a number average molecular weight in the range from 500 to 4000 g/mol, preferably in the range from 700 to 3000 g/mol and more preferably in the range from 900 to 2500 g/mol. Polytetrahydrofuran (=PTHF) is also known in the art under the designations tetramethylene glycol (=PTMG), polytetramethylene glycol ether (=PTMEG) or polytetramethylene oxides (=PTMO).

As well as the aforementioned polyetherpolyols, the polyol component (b) may also comprise customary chain extenders.

In one preferred embodiment, the polyol component comprises one or more constituents selected from
(b-1) a polyol, preferably a polyetherpolyol, having a number average molecular weight in the range from 500 g/mol to less than 3000 g/mol
(b-2) a polyol, preferably a polyetherpolyol, having a number average molecular weight in the range from 3000 g/mol to 8000 g/mol
(b-3) a chain extender having a molecular weight of less than 400 g/mol.

In one preferred embodiment, component (b-1) comprises a polyetherol or a polyesterol, more preferably a polyetherpolyol, having a number average molecular weight in the range from 500 to less than 3000 g/mol, preferably in the range from 800 to 2500 g/mol and more preferably in the range from 1000 to 2200 g/mol as components (b1).

The components (b-1) typically have an average functionality of 1.8 to 3, more preferably of 1.9 to 2.1 and especially of 2.0. Functionality here refers to the “theoretical OH functionality” calculated from the functionality of the starter molecules used.

Polytetrahydrofuran is more preferably used as component (b-1). More particularly, polytetrahydrofuran having a number average molecular weight in the range from 1000 to 2000 g/mol is used.

The components (b-1) is typically present in component (b) in an amount from 30% to 100% by weight and preferably from 50% to 90% by weight, based on the total weight of component (b).

In one preferred embodiment, component (b-2) utilizes a polyetherol or a polyesterol, more preferably a polyetherpolyol, having a number average molecular weight in the range from 3000 to 8000 g/mol, preferably in the range from 3500 to 7000 g/mol and more preferably in the range from 4000 to 6000 g/mol as components (b1).

The components (b-2) typically have an average functionality of 1.9 to 6, more preferably of 2.3 to 4 and especially of 3.0. Functionality here refers to the “theoretical OH functionality” calculated from the functionality of the starter molecules used.

Component (b-2) is more preferably a polyetherpolyol obtainable by propoxylation and/or ethoxylation of glycerol or trimethylolpropane, especially with an EO end block. This polyetherpolyol preferably has a number average molecular weight in the range from 4500 to 6000 g/mol.

The component (b-2) is typically present in component (b) in an amount from 5% to 80% by weight and preferably from 10% to 30% by weight, based on the total weight of component (b).

The polyol component (b) may further comprise chain extenders as component (b-3). Useful chain extenders are known in the art. Preference is given to using 2-alcohols having molecular weights below 400 g/mol, in particular in the range from 60 to 150 g/mol. Examples are ethylene glycol, propylene glycol, diethylene glycol, 1,4-butanediol, dipropylene glycol, tripropylene glycol. 1,4-Butanediol is preferred.

The chain extender is typically used in an amount from 5% to 20% by weight, preferably from 7% to 16% by weight and more preferably from 9% to 15% by weight, based on the total weight of component (b).

In one preferred embodiment, the reaction of the polyurethane system components (a) and (b) takes place in the absence of a blowing agent. The resulting polyurethane layer will then be a compact polyurethane. Compact polyurethane refers in the realm of the present invention to polyurethanes produced without addition of blowing agents. The polyurethane layer resulting in this embodiment typically has a density in the range from 0.6 to 1.2 kg/liter and preferably in the range from 0.8 to 1.1 kg/liter.

If appropriate, however, the polyol component (b) may for technical reasons comprise a small fraction of residual water. This will be the case in particular when no water trap is used as component (e). The residual water content is preferably below 0.5% by weight and more preferably below 0.2% by weight, based on the total weight of the component (b) used.

In one alternative embodiment, a blowing agent (c) may be added to the reaction of components (a) and (b). The addition of blowing agent preferably leads to an improvement in the breathability of the resulting polyurethane layer.

Useful blowing agents include commonly known chemically or physically acting compounds. Water may preferably be used as a chemically acting blowing agent. Examples of physical blowing agents are inert (cyclo)aliphatic hydrocarbons having from 4 to 8 carbon atoms and preferably having a boiling point of less than 60° C.

The blowing agent is generally used in an amount from 0.05% to 10% and preferably from 0.1% to 5% based on the total weight of components (b) to (f). The polyurethane layer which results in this embodiment typically has a density from 0.5 to 1.1 kg/liter and preferably from 0.7 to 0.9 kg/liter.

In one preferred embodiment, the polyol component (b) comprises a constituent (d). The constituent (d) comprises fillers. The customary fillers known in the field of polyurethane chemistry are suitable in general. Examples of suitable fillers are glass fibers, mineral fibers, natural fibers, such as flax, jute or sisal for example, glass flakes, silicates such as mica or glimmer, salts, such as calcium carbonate, chalk or gypsum.

It is preferable to use fillers which create cracks in the resulting polyurethane layer when it is being subjected to orientation. These cracks generally lead to enhanced breathability. Calcium carbonate is more preferably used as filler.

The constituent (d) is typically used in an amount from 0.5% to 60% by weight and preferably from 3% to 10% by weight based on the total weight of components (b) to (f).

In one preferred embodiment, the polyol component (b) comprises a constituent (e). The constituent (e) comprises water traps. The customary water traps known in the field of polyurethane chemistry are suitable in general. Examples of suitable water traps are zeolites, especially in the form of zeolite pastes (an example being Baylith® L Paste 3A).

The constituent (e) is typically used in an amount from 1% to 10% by weight and preferably from 3% to 8% by weight based on the total weight of components (b) to (f).

In one preferred embodiment, the reaction of components (a) and (b) takes place in the presence of a catalyst (f). The customary and known polyurethane formation catalysts are optionally used as catalysts for producing the polyurethane foams of the present invention, examples being organic tin compounds, such as tin diacetate, tin dioctoate, dibutyltin dilaurate, and/or strongly basic amines such as diazabicyclooctane, triethylamine or preferably triethylenediamine or bis(N,N-dimethylaminoethyl)ether.

The constituent (f) is typically used in an amount from 0.5% to 5% by weight and preferably from 1% to 4% by weight based on the total weight of components (b) to (f).

If appropriate, the reaction of components (a) and (b) takes place in the presence of further auxiliary and/or addition materials, examples being cell regulators, release agents, pigments, surface-active compounds and/or stabilizers acting against oxidative, thermal, hydrolytic or microbial degradation or aging.

The components (c), (d), (e) and (f) may be added not only directly to the reaction of isocyanate component (a) and polyol component (b) but also to the two components (a) and/or (b) before the reaction. Preferably, the components (c), (d), (e) and (f) are added to the polyol component (b) before the reaction.

The process of the present invention generally has components (a) and (b) being reacted in such amounts that the equivalence ratio of NCO groups to the sum total of reactive hydrogen atoms is in the range from 1:0.8 to 1:1.25 and preferably in the range from 1:0.9 to 1:1.15. A ratio of 1:1 corresponds to an NCO index of 100.

In one preferred embodiment, the polyurethane system components comprise essentially no solvent. In other words, not only the components (a) and (b) but also the components (c), (d), (e) and (f) comprise essentially no solvent. “Essentially no solvent” is to be understood as meaning that, apart from possibly manufacturing-based impurities, they comprise no solvent and that no solvent was added to the components. The solvent content is thus less than 1% by weight, preferably less than 0.1% by weight and more preferably less than 0.01% by weight based on the total weight of components (a) to (f).

The term “solvent” is common knowledge in the art. Solvent in the realm of this invention is to be understood in the widest sense as comprehending organic and inorganic liquids which are capable of dissolving other solid materials in a physical way. The prerequisite for a material to be useful as a solvent is that neither the dissolving material nor the dissolved material undergoes chemical changes in the course of the process of dissolution. Thus, the dissolved component can be recovered by physical methods of separation, such as distillation, crystallization, sublimation, evaporation and/or adsorption for example.

In this invention, the polyurethane system components comprise essentially no organic solvent. More particularly, the polyurethane system components comprise essentially no ether or glycol ether (such as diethyl ether, dibutyl ether, anisole, dioxane, monomeric tetrahydrofuran), ketones (such as acetone, butanone, cyclohexanone), esters (such as ethyl acetate), nitrogen compounds (such as dimethylformamide, pyridine, N-methylpyrrolidone, acetonitrile), sulfur compounds (such as carbon sulfide, dimethyl sulfoxide, sulfolane), nitro compounds (such as nitrobenzene), (hydro)halocarbons (such as dichloromethane, chloroform, tetrachloromethane, trichloroethene, tetrachloroethene, 1,2-dichloroethane, chlorofluorocarbons), hydrocarbons, preferably with boiling point above 60° C. (such as octane, methylcyclohexane, decalin, benzene, toluene, xylene).

The process of the present invention is preferably carried out with components (a) and (b) and also, if appropriate, (c) and (f) chosen such that the resulting polyurethane layer has a Shore A hardness (measured according to German standard specification DIN 53505) in the range from 20 to 90 and preferably of Shore A 50 to 75 after curing. The preferred hardness is obtainable for example through suitable choice of the NCO content for the polyisocyanate prepolymer.

The optional step (iii) of the process according to the present invention comprises applying a substrate layer atop the polyurethane system components. The substrate layer is preferably applied as long as the polyurethane system components are not fully cured, i.e., as long as there is still an ongoing reaction of isocyanate groups with OH groups.

In principle, the substrate layer can be any layer capable of forming an adhering bond with the resulting polyurethane layer.

The thickness of the substrate layer is typically in the range from 0.01 millimeter (mm) to 20 mm, preferably in the range from 0.1 mm to 10 mm and especially in the range from 1 mm to 5 mm.

Examples of useful release layers are layers, for example foils, composed of metal, plastic, leather and/or textile materials.

Various kinds of substrate layers are possible for the process of the present invention, examples being:

A fabric substrate layer: in this case the substrate layer can consist of one or more, identical or different, firmly interconnected plies, for example of narrowly or widely meshed wovens, knits, braids, networks (net cloths).

Batt substrate layer: sheetlike structures composed of randomly disposed fibers (examples being felts and fibrous webs), which may preferably be bound together by a binder. Batt substrate layers are usually cellulosic or textile batts consolidated with water-insoluble impregnants.

Fibrous substrate layer: articles of manufacture composed of loose, randomly disposed fibers which are consolidated by plastics being used as a binder. They are obtained for example by adhering together leather fibers (preferably obtainable from leather waste, for example from vegetable-tanned leather) with 8-40% by weight of a binder.

Foil substrate layer: articles of manufacture comprising (preferably homogeneous) foils composed of metal or plastic, for example rubber, PVC, polyamides, interpolymers and the like. A foil substrate layer preferably comprises no incorporated fiber.

One preferred embodiment utilizes a leather layer as substrate layer. When a leather layer is used, the leather in question is preferably split leather.

When a textile layer is used, the following materials will be particularly suitable to produce the textile layer: cotton, linen, polyester, polyamide and/or polyurethane.

The applying of the substrate layer atop the layer of polyurethane system components is generally effected by contacting and subsequent pressing.

The pressing pressure is preferably between 0.01 and 1 bar and more preferably between 0.05 and 0.5 bar. The pressing time is between 0.1 sec and 100 sec and preferably between 5 sec and 30 seconds (sec).

Step (iv) of the process according to the present invention comprises curing of the polyurethane system components to form the polyurethane layer. This curing may be hastened by temperature elevation, for example in an oven.

In one preferred embodiment, curing is effected at temperatures in the range from 10° C. to 80° C., more preferably in the range from 15° C. to 50° C. and especially in the range from 20° C. to 40° C.

The curing operation continues until the reaction of isocyanate groups with OH-functional groups is essentially complete. The duration of the curing operation is preferably in the range from 0.5 to 20 minutes, more preferably in the range from 1 to 10 minutes and especially in the range from 2 to 5 minutes.

Step (iv) of the process according to the present invention comprises separating the release layer from the polyurethane layer. The separating may be effected by customary methods known in the art. For example, the release layer is peeled off the polyurethane layer.

The process of the present invention may be carried out as a continuous operation or as a batch operation. It is preferably carried out as a continuous operation.

Continuous is to be understood in this context as meaning that the release layer and if appropriate the substrate layer are present in the form of bands which are continuously advanced and treated according to the process of the present invention. The bands are generally from 10 to 500 meters and preferably from 20 to 200 meters in length.

In one continuous process of the present invention, the release layer forms a quasi release band. The release layer is preferably unwound off a spindle at the start of the process, the release layer removed from the polyurethane layer in the process of the present invention may preferably be wound up again on a spindle. This wound-up release layer may be reused in the process of the present invention; that is, it is reusable. The wound-up release layer is preferably reused from 2 to 5 times.

In one continuous process of the present invention, the substrate layer forms a quasi substrate band. The substrate layer is preferably unwound off a spindle at the start of the process.

This continuous process of the present invention provides a polyurethane layer—if appropriate bonded to the substrate layer—as a product which is likewise in the form of a band. The product obtained is preferably wound up on a spindle.

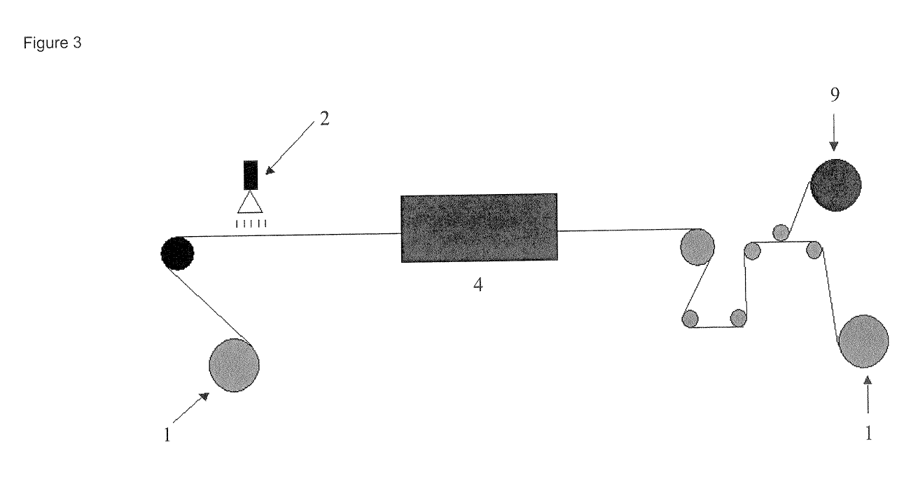

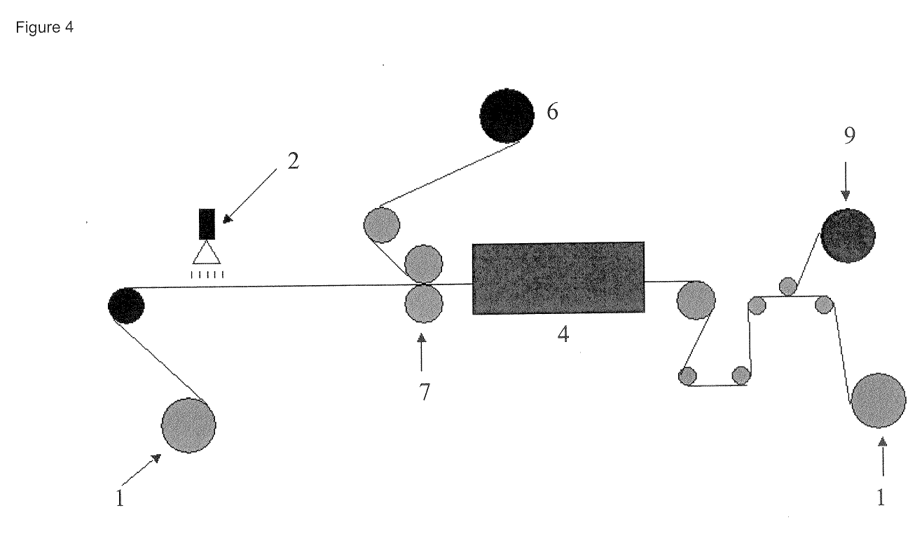

Preferred embodiments of the process according to the present invention will now be more particularly described with reference to FIGS. 3 and 4, in each of which the reference numerals are assigned the following meanings:
1 release layer
2 application of polyurethane system components
3 knife coater (optional)
4 oven (optional)
5 chill roller (optional)
6 substrate layer
7 laminating roller (optional)
8 cooling drum (optional)
9 product spindle (optional)

In one preferred embodiment, the polyurethane layer obtainable in the process of the present invention is oriented. “Oriented” is to be understood in this context as meaning that the polyurethane layer is subjected in the solid state to tension or pressure in one or two directions (=mono- or uniaxial and biaxial orientation respectively). This orientation leads to an enlargement of the dimensions by a factor of up to 10, preferably to an enlargement of the dimensions by a factor of up to 1.1 to 5 and more preferably to an enlargement of the dimensions by a factor of 1.2 to 2.

The orientation preferably leads to an improvement in the breathability of the polyurethane layer of the present invention. The breathability of the polyurethane layer of the present invention is preferably in the range from 0.5 to 15 mg/cm² and more preferably in the range from 3.5 to 8.5 mg/cm², as measured according to DIN EN ISO 14268.

The polyurethane layer obtainable by the process of the present invention, which is bonded to the substrate layer if appropriate, is useful for numerous applications.

In one preferred embodiment, the polyurethane layer according to the present invention is used as artificial leather. The present invention accordingly also provides for the use of a polyurethane layer according to the present invention as artificial leather.

The present invention further provides a polyurethane artificial leather comprising a polyurethane layer according to the present invention. A preferred aspect of the present invention is a polyurethane artificial leather obtainable by reacting a polyisocyanate prepolymer (a) obtainable by reaction of 4,4′-MDI with polytetrahydrofuran with a polyol component comprising polytetrahydrofuran and 1,4-butanediol.

Artificial leather refers in general to flexible sheetlike structures which were produced using plastics and which have leatherlike properties and/or surface constitution (embossing, for example) appropriate to the intended use.

The artificial leather of the present invention is useful for numerous applications. Examples include seat covers and interior trim of means of transport, suitcases, bags, footwear material, outerwear and the like.

In one further preferred embodiment, the polyurethane layer of the present invention is used for coating textiles. The present invention thus also provides for the use of a polyurethane layer according to the present invention for coating textiles.

The present invention further provides textile coated with a polyurethane layer which is in accordance with the present invention. In one preferred embodiment, the thickness of the polyurethane layer on the textile is in the range from 0.001 to 1 mm and more preferably in the range from 0.01 to 0.5 mm. A preferred aspect of the present invention is a textile coated with a present invention polyurethane layer obtainable by reacting a polyisocyanate prepolymer (a) obtainable by reaction of 4,4′-MDI with polytetrahydrofuran with a polyol component (b) comprising polytetrahydrofuran and 1,4-butanediol.

Examples of textiles which may be advantageously coated with a polyurethane layer which is in accordance with the present invention are swimsuits, especially diving suits, surfing suits, sportswear, materials for umbrellas, tenting and the like.

The present invention thus also provides swimsuits, especially diving suits, surfing suits, sportswear, materials for umbrellas and tenting, comprising a polyurethane layer which is in accordance with the present invention.

The example which follows illustrates the present invention.

### EXAMPLE

A process according to the present invention is carried out as per FIG. 4. The release layer used is a grained paper. The substrate used is split leather having a thickness of 1-4 mm.

The following polyurethane system components are applied by spraying: isocyanate component:

prepolymer of monomer MDI and PTHF with molecular weight 2000 g/mol polyol component:
69 parts of PTHF with molecular weight 1000 g/mol
15 parts of 1,4-butanediol
15 parts of polyetherol obtainable by propoxylation/ethoxylation of a trifunctional starter with molecular weight 5000 g/mol
1 part of catalyst

Curing at 50° C. in an oven and peeling off the release layer provides a grained artificial leather of very high visual quality.

1. A process for producing a polyurethane layer comprising
i) providing a release layer,
ii) applying polyurethane system components comprising an isocyanate component (a) and a polyol component (b), the isocyanate component (a) and the polyol component (b) being solvent free, atop the release layer,
iii) if appropriate, applying a substrate layer atop the polyurethane system components,
iv) curing the polyurethane system components to form a polyurethane layer,
v) separating the release layer from the polyurethane layer.

2. The process according to claim 1 as a continuous process.

3. The process according to claim 1 wherein the polyurethane layer is from 0.1 to 10 millimeters thick.

4. The process according to claim 1 wherein the polyurethane system components further comprise a blowing agent (c).

5. The process according to claim 1 wherein the polyurethane system components further comprise a filler (d).

6. The process according to claim 1 wherein the polyurethane layer obtained in (iv) or (v) is orientated.

7. The process according to claim 1 wherein the polyurethane system components are sprayed atop the release layer.

8. The process according to claim 1 wherein the polyurethane system components comprise, as isocyanate component (a), polyisocyanate prepolymer obtained by reaction of 4,4′-MDI with polytetrahydrofuran with a polyol component (b) comprising polytetrahydrofuran and 1,4-butanediol.

9. A polyurethane layer produced by the process according to claim 1.

10. An artificial leather comprising the polyurethane layer according to claim 9.

11. (canceled)

12. A coated textile comprising the polyurethane layer according to claim 9.
